(19) United States
(12) Patent Application Publication
(10) Pub. No.: US 2009/0262084 A1
(43) Pub. Date: Oct. 22, 2009

(54) DISPLAY CONTROL SYSTEM PROVIDING SYNCHRONOUS VIDEO INFORMATION

(75) Inventor: Hung-Huei Yu, Taipei (TW)

Correspondence Address: Muncy, Geissler, Olds & Lowe, PLLC, P.O. BOX 1364, FAIRFAX, VA, 22038-1364, US

(73) Assignee: SHUTTLE INC.

(21) Appl. No.: 12/106,185

(22) Filed: Apr. 18, 2008

(51) Int. Cl. G06F 3/041; G09G 5/00

(52) U.S. Cl. 345/173; 345/2.1; 345/211

(57) ABSTRACT

A display control system providing synchronous video information includes an information processing device and a display control module. The information processing device generates video information to be displayed on a primary display unit. The display control module includes an ancillary video unit linking to the information processing device through a signal linking means to receive the video information synchronously with the primary display unit and a control unit to output a control signal to the information processing device to process the video information. Thus users can synchronously display and maneuver the video information of the information processing device through the display control module.

### FIELD OF THE INVENTION

The present invention relates to a control system and particularly to a display control system to receive video information synchronously.

### BACKGROUND OF THE INVENTION

These days computer systems are widely used to do digital data processing and storing. They include industrial computers, personal computers, notebook computers, personal digital assistants (PDAs) and the like. In general, a computer system has a host to perform information processing and storing, a display device to enable users to read information and an input device to enter commands or signals. For instance, a personal computer may have a flat panel display and a keyboard or mouse as an input device.

When a conventional computer is in use, a signal communication line usually is provided for linking. Users must be close to the personal computer and notebook computer to do data entry and reading. With advance of technology and changes of user's operation habit, nowadays the display device is not necessary to be positioned on or close to the computer host. For instance, as digital video home appliances are increasingly popular, the display device has improved resolution and larger size to gradually replace the traditional television. In order to get better viewing quality and comfort, a greater distance has to be provided between users and the computer system. In such an environment entering commands into the computer system has to rely on an input device linking to the computer system at a closer distance. This creates inconvenience in use. On the other hand, when a user wants to use a computer host to make speech or presentation, he/she has to be confined at a location close to the computer system or walk to and for constantly to do operation on the input device due to the input device being linked to the computer host. This often creates troubles for the user. To free users from the constraint of the conventional communication line, wireless technology is widely adopted in computer systems, such as keyboard and mouse conforming to communication protocols like infrared rays or Bluetooth. There are also other wireless communication techniques being proposed to transmit data between remote input devices and a notebook computer. Reference can be found in U.S. Pat. Nos. 6,163,326, 6,424,335 and 6,784,870. While those input devices free users from the constraint of communication line, and users can control operation of the host through keys or a touch pad on the input devices, the users still have to read information on the only display device to make sure that control operation is correct. If the display device is located at a distance or an awkward spot due to space constraint, reading is difficult and user's operation is still hindered. To remedy this problem, U.S. Pat. No. 7,047,339 proposes a computer system with a detachable and portable device that has a second display device and a control means. Through a wireless communication means information from the computer can be received and controlled. However, it is mainly limited to data for E-mail, calendar, mailing list or the like, and cannot perform full scope synchronous monitoring and operation.

### SUMMARY OF THE INVENTION

The primary object of the present invention is to provide a display control system to allow a display device linking to an information processing device (such as a computer host) to passively receive video information generated by the information processing device and also perform active control of the information processing device thereby to achieve synchronous video information display and control functions. To achieve the foregoing object the display control system of the invention includes an information processing device and a display control module. The information processing device aims to generate video information to be displayed on a primary display unit. The display control module includes an ancillary video unit linking to the information processing device through a signal linking means to receive the video information synchronously with the primary display unit and a control unit to send a control signal to the information processing device to process the video information.

The display control module linking to the information processing device, aside from controlling the video information in the information processing device, can also synchronously display the video information presenting on the primary display unit. Thus users are not confined to where the information processing device or the primary display unit is located, and can use the information processing device according to their habits or requirements. The information processing device also can be used more flexibly.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of an embodiment of the display control system of the invention.

FIG. 2 is a schematic view of the display control system of the invention used on a personal computer with a signal link established.

FIG. 3 is a schematic view of the display control system of the invention used on a notebook computer with a signal link established.

FIGS. 4A, 4B and 4C are schematic views of the display control system of the invention used on a home video equipment with a signal link established.

### DETAILED DESCRIPTION OF THE PREFERRED EMBODIMENTS

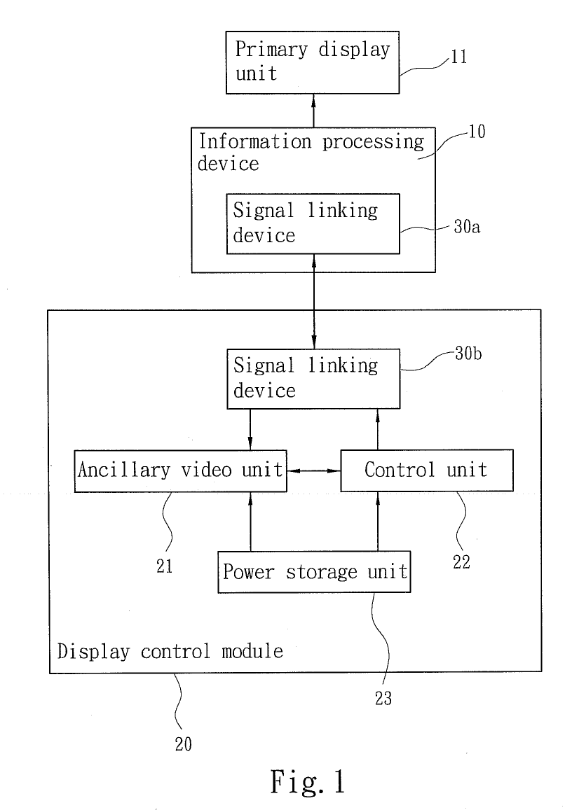

Please refer to FIG. 1 for the structural block diagram of an embodiment of the display control system to provide synchronous video information of the invention. It includes an information processing device 10 and a display control module 20. The information processing device 10 aims to generate video information to be displayed on a primary display unit 11. The display control module 20 includes an ancillary video unit 21 linking to the information processing device 10 through a signal linking means to receive the video information synchronously with the primary display unit 11 and a control unit 22 to output a control signal to the information processing device 10 to process the video information (such as functions of playing, fast forward, backward, pause and the like). The display control module 20 may include a power storage unit 23 (such as a battery) or an external power cord (not shown in the drawings) to get electric power needed for operation. In this embodiment the signal linking means is connected to signal linking devices 30a and 30b located respectively on the information processing device 10 and the display control module 20 to transmit the video information. The signal linking devices 30a and 30b may be physical connection interfaces such as Universal Series Bus (USB) Modules, IEEE 1394, Digital Visual Interface (DVI), Video Graphic Array (VGA), or wireless communication modules such as Bluetooth Modules, Infrared Ray modules, Wireless USB modules, IEEE 802.11 or the like.

When in use the information processing device 10 and the display control module 20 are linked through the signal linking devices 30a and 30b. Video information stored in the information processing device 10 is sent to the primary display device 11 corresponding to the information processing device 10, and also sent to the display control module 20 through the signal linking devices 30a and 30b so that the primary display unit 11 and the ancillary video unit 21 on the display control module 20 can synchronously display the video information. In addition, through the control unit 22 on the display control module 20 users can output a control signal to the information processing device 10 to process the video information. The control unit 22 may be a command input device such as a directional control key, keyboard, mouse or the like, and also may be a touch panel module located on the ancillary video unit 21. Through functional windows of the touch panel module users can issue commands to control the information processing device 10.

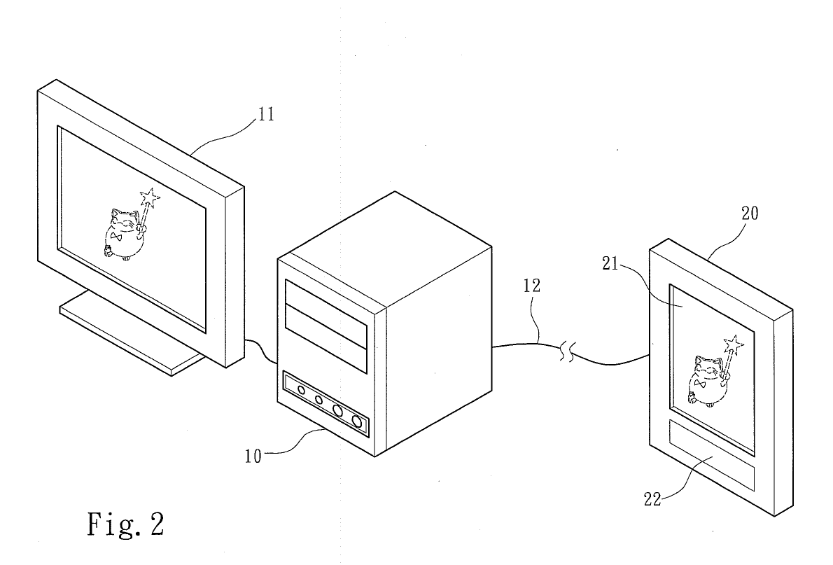

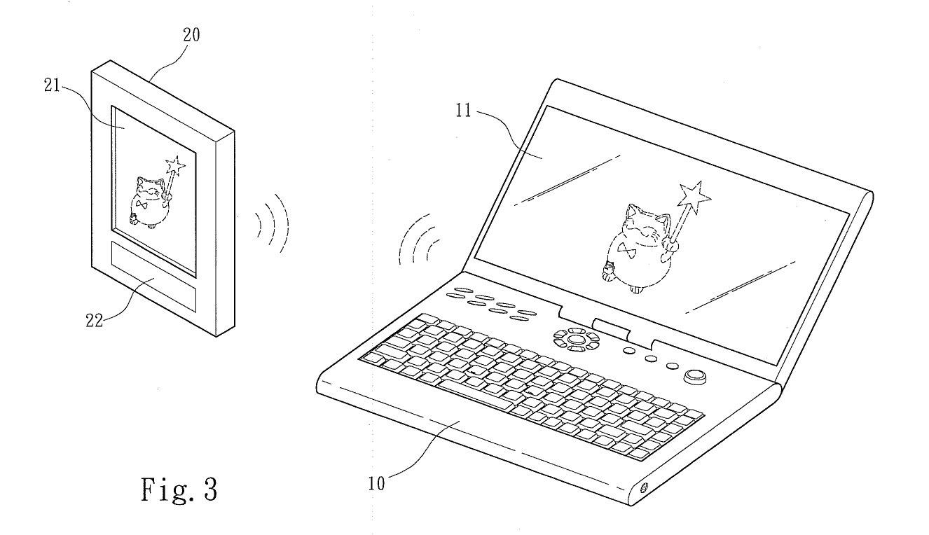

The invention may be adopted to various types of computer systems to transmit video information between the information processing device 10 and the display control module 20 through different signal linking means. Referring to FIG. 2, the information processing device 10 is a personal computer. Through a physical linking interface such as a signal transmission line 12 the signal linking devices 30a and 30b can be connected to send the video information to the display control module 20. FIG. 3 illustrates another example in which the information processing device 10 is a portable notebook computer which communicates with the display control module 20 to transmit video information through a wireless communication module.

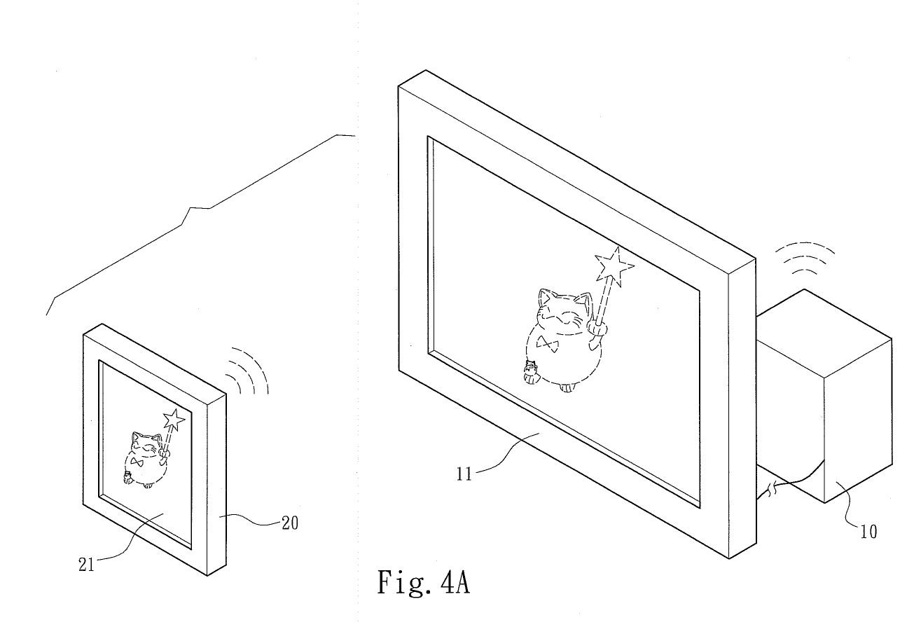

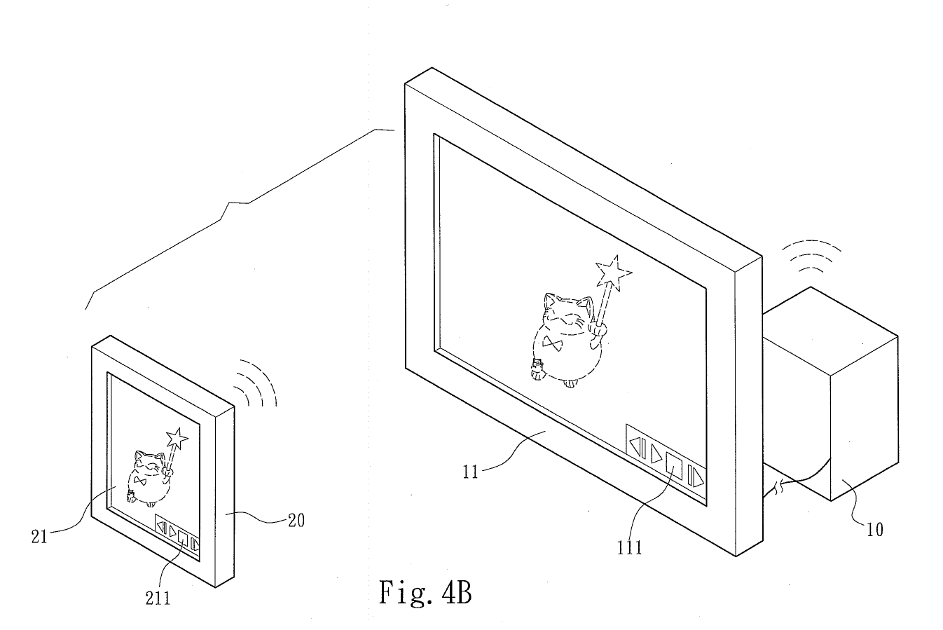

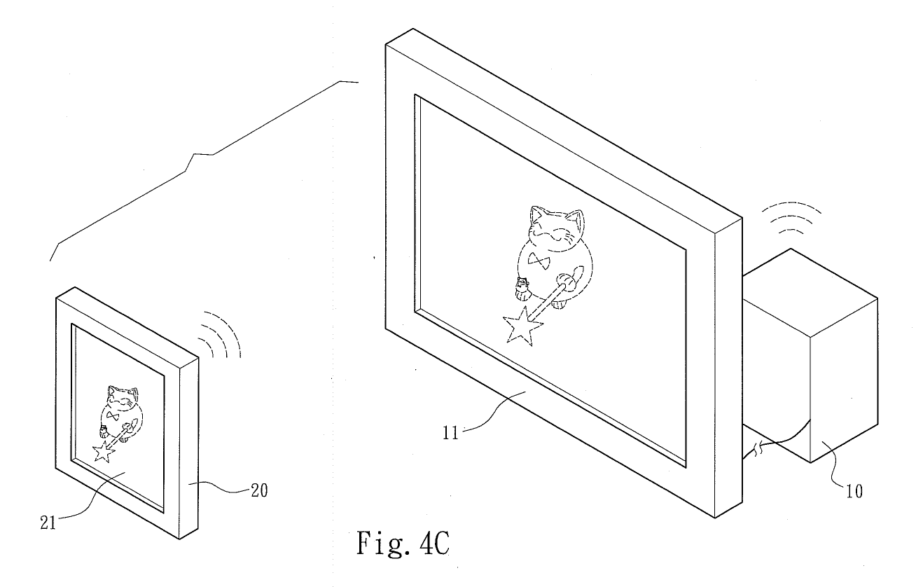

Refer to FIG. 4A for an embodiment of the invention adopted on a home video equipment. The primary display unit 11 is a display panel (such as TV screen, projection screen or the like) linking to the information processing device 10. The information processing device 10 may be a computer host or a multimedia player such as a video player or digital TV set-top box or the like to connect the primary display unit 11. The information processing device 10 generates video information transmitted to the primary display unit 11 which serves as a screen to present the video information to users. In this embodiment a wireless communication means is adopted between the display control module 20 and the information processing device 10. Through the invention the ancillary video unit 21 of the display control module 20 can synchronously display the video information with the primary display unit 11. Meanwhile, the control unit 22 also can control the video information. FIG. 4B shows that the information processing device 10 has a control menu 111 to control the primary display unit 11 to display the video information. The ancillary video unit 21 also has another control menu 211 of a similar function to be used by the users to do operation. In the event that a user wants to control display function, he/she can do that by maneuvering the another control menu 211 on display control module 20 so that the control unit 22 can send a control signal through the wireless communication means to the information processing device 10 to process the video information and the video information may be displayed according to user's requirement (referring to FIG. 4C). The display control module 20 may be a peripheral device attached to the information processing device 10 or a portable electronic device such as a mobile phone, mobile video player, remote controller or the like. Therefore user can monitor and control the video information displayed on the primary display unit 11 through the display control module 20 as desired.

As a conclusion, the display control system of the invention provides the display control module 20 linking to the information processing device 10 through a signal link and also has the control module 22 sending a display control signal to the information processing device 10, and the ancillary video unit 21 to receive the video information generated by the information processing device 10. Compared with the traditional computer system users can move at a location remote from the information processing device 10 (computer system). Through the display control module 20 the video information on the primary display unit 11 can be displayed synchronously and control of the video information can be performed as desired. Hence the users are no longer constrained to a location close to the information processing device 10 or the primary display unit 11, and can perform monitoring and operation of the video information in the information processing device 10 according to their habits or requirements. As a result use convenience of the computer system can be greatly improved.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A display control system providing synchronous video information, comprising:
an information processing device to generate video information to be displayed on a primary display unit; and
a display control module which has an ancillary video unit linking to the information processing device through a signal linking means to synchronously receive the video information with the primary display unit and a control unit to output a control signal to the information processing device to process the video information.

2. The display control system of claim 1, wherein the display control module is a portable electronic device.

3. The display control system of claim 1, wherein the signal linking means is a physical connection interface.

4. The display control system of claim 1, wherein the signal linking means is a wireless communication module.

5. The display control system of claim 1, wherein the display control module includes a power storage unit.

6. The display control system of claim 1, wherein the control unit is a command input device.

7. The display control system of claim 1, wherein the control unit is a touch panel module.
